(19) United States
(12) Patent Application Publication
(10) Pub. No.: US 2023/0315106 A1
(43) Pub. Date: Oct. 5, 2023

(54) Method and System for Robot Automatic Charging, Robot, and Storage Medium

(71) Applicant: Suzhou Cleva Precision Machinery & Technology Co., Ltd., Suzhou, Jiangsu Province (CN)

(72) Inventors: Xue Ren, Suzhou, Jiangsu Province (CN); Shaoming Zhu, Suzhou, Jiangsu Province (CN)

(21) Appl. No.: 18/044,111

(22) PCT Filed: Nov. 20, 2020
(86) PCT No.: PCT/CN2020/130293

§ 371 Date: Mar. 6, 2023

(30) Foreign Application Priority Data
Oct. 26, 2020 (CN) 202011155311.7

(51) Int. Cl. G05D 1/02

(52) U.S. Cl. CPC G05D 1/0217; G05D 1/0225; G05D 1/0246

(57) ABSTRACT

The present invention provides an automatic charging method and system for a robot, a robot, and a storage medium. The method comprises: S1, recording coordinates of a position A of a charging station; S2, when the robot receives a charging instruction, recording coordinates of a current position B of the robot; S3, after driving the robot to walk a preset distance straight with the coordinates of the position B as a starting point, recording coordinates of a current position C of the robot; S4, calculating a deflection angle and deflection direction of the robot relative to the charging station according to the coordinates of the position A, the position B and the position C; and S5, driving the robot to search for and arrive at the charging station according to the deflection angle and deflection direction. The automatic charging method and system for a robot, a robot, and a storage medium provided in the present invention have the advantages that a charging path can be planned in real time through the positions of the charging station and the robot, so as to save the charging time and improve the use performance of the robot.

### TECHNICAL FIELD

The present invention relates to the field of intelligent control, in particular to an automatic charging method and system for a robot, a robot, and a storage medium.

### BACKGROUND

Low repetition rate and high coverage are the goals pursued by mobile robots such as traversing robots for vacuuming, lawn mowing and swimming pool cleaning. Taking a mobile robot like an intelligent robot mower as an example, the robot mower takes a lawn surrounded by the boundary as the working region to mow the lawn, and the outside of the lawn is defined as the non-working region.

In the prior art, the charging system of the robot is mainly composed of a charging station and a boundary line connected to the charging station. When the robot needs to be charged, the robot needs to walk along the boundary line to find a charging pile for connection and charging. In this charging method, the robot searches for the boundary without the principle of proximity. When there are obstacles near the boundary line, the robot needs to randomly search for the boundary line again. Thus, time is wasted, and the power consumption of the robot is increased accordingly.

### SUMMARY

In order to solve the above technical problems, the objectives of the present invention are to provide an automatic charging method and system for a robot, a robot, and a storage medium.

In order to achieve one of the above objectives of the present invention, an embodiment of the present invention provides an automatic charging method for a robot, the method comprising:
S1, recording coordinates of a position A of a charging station;
S2, when the robot receives a charging instruction, recording coordinates of a current position B of the robot;
S3, after driving the robot to walk a preset distance straight with the coordinates of the position B as a starting point, recording coordinates of a current position C of the robot;
S4, calculating a deflection angle and deflection direction of the robot relative to the charging station according to the coordinates of the position A, the position B and the position C;
S5, driving the robot to search for and arrive at the charging station according to the deflection angle and deflection direction.

Through the above method, a charging path can be planned in real time through the positions of the charging station and the robot, so as to save the charging time and improve the use performance of the robot.

As a further improvement of an embodiment of the present invention, a method for calculating the deflection angle comprises:
configuring the deflection angle as an angle of a vector [symbol] and a vector [symbol] and representing the deflection angle as
Angle; and configuring each recorded position to be represented by latitude and longitude coordinates;
then:

$$∠Angle = A COS ( \frac{( x 3 - x 2 ) ( x 1 - x 3 ) + ( y 3 - y 2 ) ( y 1 - y 3 )}{\sqrt{{( x 3 - x 2 )}^{2} {( y 3 - y 2 )}^{2}} \sqrt{{( x 1 - x 3 )}^{2} {( y 1 - y 3 )}^{2}}} ) * 180 ° / π ,$$

where
(x1,y1) represents the longitude and latitude coordinates of the position A,
(x2,y2) represents the longitude and latitude coordinates of the position B,
(x3,y3) represents the longitude and latitude coordinates of the position C,
x1, x2, x3 represent longitude coordinate values, and
y1, y2, y3 represent latitude coordinate values.

Through the above preferred embodiment, the deflection angle of the robot is calculated to improve the efficiency.

As a further improvement of an embodiment of the present invention, S5 comprises:
determining whether the deflection angle is less than a preset angle threshold,
if so, after replacing the recorded coordinates of the position B with the coordinates of the current position C, performing S2 to S5 cyclically until arriving at the charging station;
otherwise, replacing the recorded coordinates of the position B with the coordinates of the current position C, driving the robot to rotate the deflection angle on site based on the new coordinates of the position B, and performing S2 to S5 cyclically until arriving at the charging station.

Through the above preferred embodiment, the charging path can be planned in real time through the positions of the charging station and the robot, so as to save the charging time and improve the use performance of the robot.

As a further improvement of an embodiment of the present invention, a method for calculating the deflection direction comprises:
calculating a deflection parameter D of the robot relative to the charging station according to the coordinates of the position A, the position B and the position C, where

D=(x2−x1)(y3−y1)−(y2−y1)(x3−x1);
if the deflection parameter is greater than 0, driving the robot to deflect to the left;
if the deflection parameter is less than 0, driving the robot to deflect to the right.

Through the above preferred embodiment, the deflection parameter of the robot is confirmed, and the deflection direction is confirmed according to the deflection parameter, thereby improving the efficiency.

As a further improvement of an embodiment of the present invention, between S2 and S3, the method further comprises:
calculating a distance between the robot and the charging station according to the coordinates of the position A and the position B;
if the distance between them is greater than a preset length threshold, performing S3;
if the distance between them is not greater than the preset length threshold, driving the robot to search for the charging station directly.

Through the above preferred embodiment, the charging path can be planned in real time through the positions of the charging station and the robot, so as to save the charging time and improve the use performance of the robot.

As a further improvement of an embodiment of the present invention, driving the robot to search for the charging station directly comprises:
turning on a camera device, identifying the charging station through the camera device, and driving the robot to plan a walking path and arrive at the charging station according to the identification result.

Through the above preferred embodiment, the method for the robot to search for the charging station directly is described in detail, which improves the use performance of the robot.

As a further improvement of an embodiment of the present invention, driving the robot to search for the charging station directly comprises:
driving the robot to search for and arrive at a charging cable connected to the nearest charging station, and after arriving at the charging cable, driving the robot to arrive at the charging station along the charging cable.

Through the above preferred embodiment, the method for the robot to search for the charging station directly is described in detail, which improves the use performance of the robot.

In order to achieve another objective of the above invention, an embodiment of the present invention provides an automatic charging system for a robot, the system comprising: an acquisition module, configured to record coordinates of a position A of a charging station,
when the robot receives a charging instruction, record coordinates of a current position B of the robot, and
after driving the robot to walk a preset distance straight with the coordinates of the position B as a starting point, record coordinates of a current position C of the robot; and
a processing module, configured to calculate a deflection angle and deflection direction of the robot relative to the charging station according to the coordinates of the position A, the position B and the position C, and
drive the robot to search for and arrive at the charging station according to the deflection angle and deflection direction.

Through the above system, a charging path can be planned in real time through the positions of the charging station and the robot, so as to save the charging time and improve the use performance of the robot.

In order to achieve one of the above objectives of the present invention, an embodiment of the present invention provides a robot, comprising a memory and a processor, the memory storing a computer program, and the processor implementing the steps of the above-mentioned automatic charging method for the robot when executing the computer program.

In order to achieve one of the above objectives of the present invention, an embodiment of the present invention provides a readable storage medium, storing a computer program that, when executed by a processor, implements the steps of the above-mentioned automatic charging method for a robot.

Compared with the prior art, the automatic charging method and system for a robot, the robot, and the storage medium of the present invention have the advantages that a charging path can be planned in real time through the positions of the charging station and the robot, so as to save the charging time and improve the use performance of the robot.

### BRIEF DESCRIPTION OF THE DRAWINGS

FIG. 1 is a schematic flowchart of an automatic charging method for a robot according to an embodiment of the present invention;

FIG. 2 is a schematic diagram of a specific example of the present invention;

FIG. 3 is a schematic flowchart of an automatic charging method for a robot according to a preferred embodiment of the present invention; and

FIG. 4 is a schematic diagram of modules of an automatic charging system for a robot according to the present invention.

### DETAILED DESCRIPTION

The present invention will be described in detail below with reference to various embodiments shown in the accompanying drawings. However, these embodiments do not limit the present invention. Structures, methods, or functional transformations made by those of ordinary skill in the art based on these embodiments are all included within the protection scope of the present invention.

The robot system of the present invention may be a robot mower system, a sweeping robot system, a snow sweeper system, a leaf suction machine system, a golf course ball picker system, etc. Each system can automatically walk in a working region and perform corresponding work. In specific examples of the present invention, the robot mower system is taken as an example for detailed description. Correspondingly, the working region may be a lawn.

The robot mower system usually comprises: a robot mower (RM) and a charging station. The robot mower comprises: a body, and a walking unit and a control unit arranged on the body. The walking unit is configured to control the walking, turning, etc. of the robot; the control unit is configured to plan a walking direction and walking path of the robot, store external parameters acquired by the robot, process and analyze the acquired parameters, and specifically control the robot according to the processing and analyzing results; and the control unit is, for example, an MCU or a DSP. The robot and the charging station can be connected by inserting a card or a pin for charging, and the robot can also be charged wirelessly, which will not be described in detail here. It should be noted that the robot mower of the present invention further comprises: a GPS positioning device, through which the position of the charging station and the position of the robot can be recorded, where the positions are recorded with coordinates in multiple ways, for example: recorded with coordinates in an electronic map. In a specific example of the present invention, the latitude and longitude coordinates of the charging station and the robot are recorded.

The robot mower of the present invention may further optionally comprise: a camera device and a charging cable identification device that are arranged in cooperation with the control unit. The camera device is configured to acquire a scenario within a certain range of viewing. The camera device of the present invention is mainly configured to identify the charging station. For example: the camera device identifies the position of the charging station by means of image analysis. The charging cable identification device is mainly configured to identify a charging cable, for example, identify the charging cable connected to the charging station by means of electromagnetic induction. Further, the control unit is combined with the GPS positioning device, the camera device, and the charging cable identification device to control the robot to search for the charging station, and plans an optimal path from the current position to a charging position, which will be described in detail below.

In addition, the robot further comprises: various sensors and storage modules, such as an EPROM, a Flash or an SD card, as well as a working mechanism for working, and a power supply. In this embodiment, the working mechanism comprises a mowing cutter head, and various sensors for sensing the walking state of the walking robot, such as toppling, off-ground, collision sensors, geomagnetism, and gyroscopes etc., which will not be described in detail here.

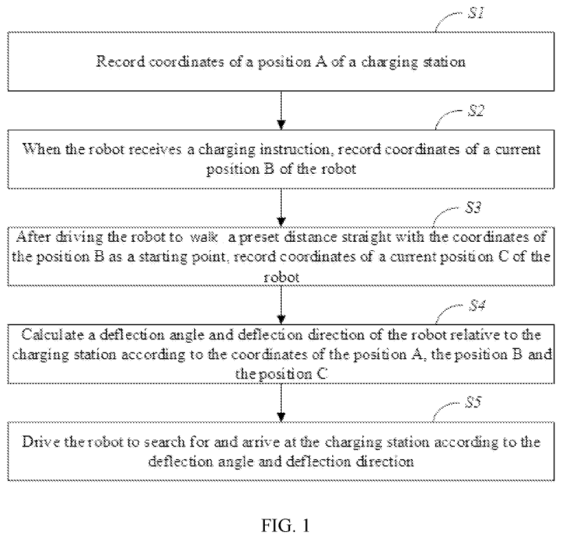

As shown in FIG. 1, an automatic charging method for a robot according to a first embodiment of the present invention comprises the following steps:
S1: Record coordinates of a position A of a charging station;
S2: When the robot receives a charging instruction, record coordinates of a current position B of the robot;
S3: After driving the robot to walk a preset distance straight with the coordinates of the position B as a starting point, record coordinates of a current position C of the robot;
S4: Calculate a deflection angle and deflection direction of the robot relative to the charging station according to the coordinates of the position A, the position B and the position C; and
S5: Drive the robot to search for and arrive at the charging station according to the deflection angle and deflection direction.

For S1, the coordinates of the position A of the charging station may be recorded in many ways, e.g.: positioning in an electronic map, global GPS positioning, etc. In a specific example of the present invention, the robot is initialized at the charging station, and records the current latitude and longitude coordinates of the charging station through GPS for subsequent calculation call. In other embodiments of the present invention, a position at a fixed distance from the charging station may also be recorded, and the position coordinates of the charging station are acquired by calculation.

For S2, the robot records the position B of the robot in the same way as positioning the charging station. Usually, when the robot works, a charging instruction is issued to the robot by determining various rules. The rules are, for example: the available time of the battery is less than a certain value, the power of the battery is less than a certain value, the working time of the robot reaches a certain value, etc. When the robot receives the charging instruction, the coordinates of the current position B are recorded, and a charging return path of the robot is planed according to the coordinates of the position A and the position B.

For S3, the preset distance is a distance constant value, and can be specifically set as required. In a preferred embodiment of the present invention, the preset distance may be set according to the accuracy of the GPS positioning device. For example: the positioning accuracy of the GPS positioning system is 1 m, that is, when the distance between two positions is more than 1, the coordinates of the two positions are different. In this way, the preset distance may be set to 2 m or more.

Preferably, for S3, after the robot receives the charging instruction, the robot is driven to walk the preset distance along a straight line formed by the axis of the robot with the coordinates of the position B as a starting point, that is, its walking direction remains unchanged; and after the robot walks the preset distance, the coordinates of the current position C of the robot are recorded, where the coordinates of the position C are also latitude and longitude coordinates in the same measurement unit as the position A.

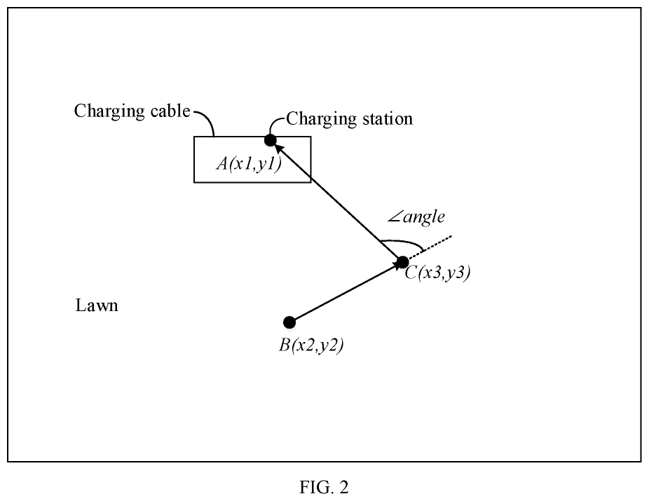

With reference to FIG. 2, S4 comprises: configuring the deflection angle as an angle of a vector [symbol] and a vector [symbol] and representing the deflection angle as Angle; and configuring each recorded position to be represented by latitude and longitude coordinates; then:

$$∠Angle = A COS ( \frac{( x 3 - x 2 ) ( x 1 - x 3 ) + ( y 3 - y 2 ) ( y 1 - y 3 )}{\sqrt{{( x 3 - x 2 )}^{2} {( y 3 - y 2 )}^{2}} \sqrt{{( x 1 - x 3 )}^{2} {( y 1 - y 3 )}^{2}}} ) * 180 ° / π ,$$

where
(x1,y1) represents the longitude and latitude coordinates of the position A,
(x2,y2) represents the longitude and latitude coordinates of the position B,
(x3,y3) represents the longitude and latitude coordinates of the position C,
x1, x2, x3 represent longitude coordinate values, and
y1, y2, y3 represent latitude coordinate values.

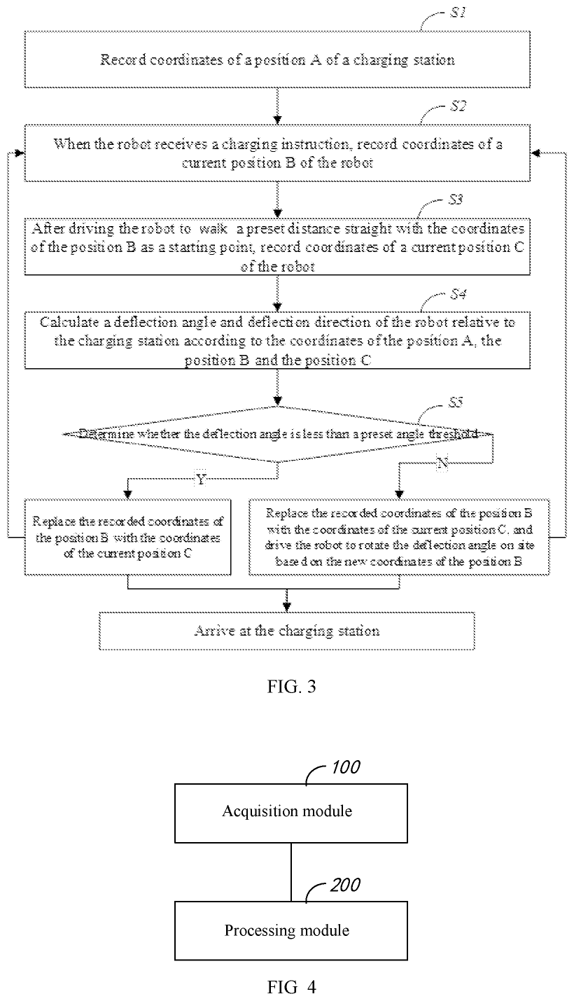

Preferably, with reference to FIG. 3, S5 comprises: determining whether the deflection angle is less than a preset angle threshold, and if so, after replacing the recorded coordinates of the position B with the coordinates of the current position C, performing S2 to S5 cyclically until arriving at the charging station; otherwise, replacing the recorded coordinates of the position B with the coordinates of the current position C, driving the robot to rotate the deflection angle on site based on the new coordinates of the position B, and performing S2 to S5 cyclically until arriving at the charging station.

The angle threshold is a preset angle constant value. When the deflection angle is between 0 degree and the angle threshold, the advancing direction of the robot is approximate to the straight extension direction from the current position to the charging station. In this case, the heading of the robot does not need to be adjusted, as long as S3 to S5 are continued, and the robot can search for and arrive at the charging station according to an optimal path.

In a preferred embodiment of the present invention, a method for calculating the deflection direction comprises: calculating a deflection parameter of the robot relative to the charging station according to the coordinates of the position A, the position B and the position C, and confirming the deflection direction of the robot according to the deflection parameter.

In a specific embodiment of the present invention, the deflection parameter is configured to be represented by D, then:

D=(x2−x1)(y3−y1)−(y2−y1)(x3−x1);
If the deflection parameter is greater than 0, the robot is driven to deflect to the left; and
if the deflection parameter is less than 0, the robot is driven to deflect to the right.

It can be understood that, in this embodiment, the purpose of calculating the deflection parameter D is to determine the positional relationship between the coordinate point A where the charging station is located and the vector ≅, where D>0 indicates that the point A is on the left of the vector [symbol] , D<0 indicates that the point A is on the right of the vector [symbol] , and D=0 indicates that the point A is on the vector [symbol] .

in a specific embodiment of the present invention, when A is on the vector [symbol] , the deflection angle ∠ Angle is 0°. Then, ∠ Angle is less than the preset angle threshold, and no deflection is required. After the robot rotates the deflection angle from the current position according to the calculated deflection direction, its high-probability walking path is a straight path toward the charging station, and after S2 to S5 are performed cyclically, the robot gradually approaches and arrives at the charging station. Of course, before the robot arrives at the charging station, natural angle changes may occur due to special circumstances, such as encountering obstacles. However, S2 to S5 are performed cyclically before the robot arrives at the charging station in this application. In this way, before the robot arrives at the charging station, even if emergencies occur, the robot always searches for the optimal path back to the charging station.

In a preferred embodiment of the present invention, between S2 and S3 the method further comprises: calculating a distance between the robot and the charging station according to the coordinates of the position A and the position B; if the distance between them is greater than a preset distance length threshold, performing S3; and if the distance between them is not greater than the preset length threshold, driving the robot to search for the charging station directly.

Specifically, driving the robot to search for the charging station directly comprises: driving the robot to search for and arrive at a charging cable connected to the nearest charging station, and after arriving at the charging cable, driving the robot to arrive at the charging station along the charging cable; and/or turning on a camera device, identifying the charging station through the camera device, and driving the robot to plan a walking path and arrive at the charging station according to the identification result.

As can be understood, the method of returning to the charging station along the boundary and the method of identifying and arriving at the charging station through the camera device are both existing technologies, and will not be described in detail here.

In addition, it should be noted that the charging cable in this embodiment is usually connected to the charging station and has a short path. For example, the length of the charging cable is set to be 1 m. The main purpose of setting the charging cable is to search for the charging station, which will not be further repeated here.

In an embodiment of the present invention, a robot is further provided, comprising a memory and a processor, the memory storing a computer program, and the processor implementing the steps of the automatic charging method for the robot according to any of the forgoing embodiments when executing the computer program.

In an embodiment of the present invention, a readable storage medium is further provided, storing a computer program that, when executed by a processor, implements the steps of the automatic charging method for a robot according to any of the forgoing embodiments.

With reference to FIG. 4, an automatic charging system for a robot is provided, the system comprising: an acquisition module 100 and a processing module 200.

The acquisition module 100 is configured to record coordinates of a position A of a charging station; when the robot receives a charging instruction, record coordinates of a current position B of the robot; and after driving the robot to walk a preset distance straight with the coordinates of the position B as a starting point, record coordinates of a current position C of the robot.

The processing module 200 is configured to drive the robot to walk, and calculate a deflection angle and deflection direction of the robot relative to the charging station according to the coordinates of the position A, the position B and the position C; and drive the robot to search for and arrive at the charging station according to the deflection angle and deflection direction.

Further, the acquisition module 100 is used to implement S1 to S3; and the processing module 200 is used to implement S4 and S5. Those skilled in the art can clearly understand that, for the convenience and brevity of the description, the specific working process of the system described above may be referred to the corresponding process in the foregoing method embodiments, which will not be repeated here.

To sum up, the automatic charging method and system for a robot, the robot, and the storage medium of the present invention have the advantages that a charging path can be planned in real time through the positions of the charging station and the robot, so as to save the charging time and improve the use performance of the robot.

In the several embodiments provided in this application, it should be understood that the disclosed modules, systems and methods can all be implemented in other ways. The system embodiment described above is only illustrative. The division of the modules is only a logic function division, and other divisions may be used in practice. For example, a plurality of modules or components may be combined or integrated to another system, or some features may be neglected or not executed.

The modules described as separate components may be or may not be physically separated, and the components displayed as modules may be or may not be physical modules, that is, the components may be located at one place or may also be distributed on a plurality of network modules. Some or all of the modules may be selected according to actual requirements to achieve the objective of the solution in this embodiment.

In addition, each functional module in each embodiment of the present application may be integrated into one processing module, or each module may exist physically alone, or two or more modules may be integrated into one module. The integrated modules may be implemented in the form of hardware, or may be implemented in the form of hardware plus software function modules.

Finally, it should be noted that the above embodiments are only used to illustrate the technical solutions of the present application, but not to limit them; although the present application is described in detail with reference to the foregoing embodiments, those of ordinary skill in the art should understand that modifications can still be made to the technical solutions described in the foregoing embodiments, or equivalent substitutions can be made to some of the technical features; and these modifications or substitutions do not make the essence of the corresponding technical solutions deviate from the spirit and scope of the technical solutions of the embodiments of the present application.

1. An automatic charging method for a robot comprising the steps of:
S1, recording coordinates of a position A of a charging station;
S2, when the robot receives a charging instruction, recording coordinates of a current position B of the robot;
S3, after driving the robot to walk a preset distance straight with the coordinates of the position B as a starting point, recording coordinates of a current position C of the robot;
S4, calculating a deflection angle and a deflection direction of the robot relative to the charging station according to the coordinates of the position A, the position B, and the position C; and
S5, driving the robot to search for and arrive at the charging station according to the deflection angle and the deflection direction.

2. The automatic charging method for a robot according to claim 1, wherein the step of calculating the deflection angle comprises:
configuring the deflection angle as an angle of a vector [symbol] and a vector [symbol] and representing the deflection angle as Angle; and
configuring each recorded position to be represented by latitude and longitude coordinates;
then:
$$∠Angle = A COS ( \frac{( x 3 - x 2 ) ( x 1 - x 3 ) + ( y 3 - y 2 ) ( y 1 - y 3 )}{\sqrt{{( x 3 - x 2 )}^{2} {( y 3 - y 2 )}^{2}} \sqrt{{( x 1 - x 3 )}^{2} {( y 1 - y 3 )}^{2}}} ) * 180 ° / π ,$$
where
(x1,y1) represents the longitude and latitude coordinates of the position A,
(x2,y2) represents the longitude and latitude coordinates of the position B,
(x3,y3) represents the longitude and latitude coordinates of the position C,
x1, x2, x3 represent longitude coordinate values, and
y1, y2, y3 represent latitude coordinate values.

3. The automatic charging method for a robot according to claim 2, wherein step S5 comprises:
determining whether the deflection angle is less than a preset angle threshold,
if so, after replacing recorded coordinates of the position B with coordinates of the current position C, performing steps S2 to S5 cyclically until arriving at the charging station;
otherwise, replacing the recorded coordinates of the position B with the coordinates of the current position C, driving the robot to rotate the deflection angle on site based on the new coordinates of the position B, and performing steps S2 to S5 cyclically until arriving at the charging station.

4. The automatic charging method for a robot according to claim 1, wherein the step of calculating the deflection direction comprises:
calculating a deflection parameter D of the robot relative to the charging station according to the coordinates of the position A, the position B and the position C, where
D=(x2−x1)(y3−y1)−(y2−y1)(x3−x1);
if the deflection parameter is greater than 0, driving the robot to deflect to the left; and
if the deflection parameter is less than 0, driving the robot to deflect to the right.

5. The automatic charging method for a robot according to claim 1, characterized in that wherein between steps S2 and S3, the method further comprises:
calculating a distance between the robot and the charging station according to the coordinates of the position A and the position B;
if the distance between them is greater than a preset length threshold, performing step S3; and
if the distance between them is not greater than the preset length threshold, driving the robot to search for the charging station directly.

6. The automatic charging method for a robot according to claim 5, wherein the step of driving the robot to search for the charging station directly comprises:
turning on a camera device, identifying the charging station through the camera device, and driving the robot to plan a walking path and arrive at the charging station according to the identification.

7. The automatic charging method for a robot according to claim 5, wherein the step of driving the robot to search for the charging station directly comprises:
driving the robot to search for and arrive at a charging cable connected to the nearest charging station, and after arriving at the charging cable, driving the robot to arrive at the charging station along the charging cable.

8. An automatic charging system for a robot comprising:
an acquisition module, configured to record coordinates of a position A of a charging station,
when the robot receives a charging instruction, recording coordinates of a current position B of the robot, and
after driving the robot to walk a preset distance straight with the coordinates of the position B as a starting point, recording coordinates of a current position C of the robot; and
a processing module, configured to calculate a deflection angle and a deflection direction of the robot relative to the charging station according to the coordinates of the position A, the position B, and the position C, and configured to drive the robot to search for and arrive at the charging station according to the deflection angle and the deflection direction.

9. A robot, comprising a memory and a processor, the memory storing a computer program, wherein the processor implements the steps of the automatic charging method for the robot according to claim 1 when executing the computer program.

10. A readable storage medium, storing a computer program thereon, wherein when the computer program is executed by a processor, the steps of the automatic charging method for the robot according to claim 1 are implemented.
